(19) United States
(12) Patent Application Publication
(10) Pub. No.: US 2026/0336718 A1
(43) Pub. Date: Oct. 29, 2026

(54) SEAT RAIL MOUNTING STRUCTURE

(71) Applicants: TOYOTA JIDOSHA KABUSHIKI KAISHA, Aichi-ken (JP); TOYOTA BOSHOKU KABUSHIKI KAISHA, Aichi-ken (JP)

(72) Inventors: Tomoya TAKEUCHI, Anjo-shi (JP); Tomohiro HIRANO, Seto-shi (JP)

(21) Appl. No.: 19/646,567

(22) Filed: Apr. 14, 2026

(30) Foreign Application Priority Data
Apr. 23, 2025 (JP) 2025-071203

(51) Int. Cl. B62D 25/20; B60K 1/04; B60N 2/015

(52) U.S. Cl. CPC B62D 25/20; B60K 1/04; B60N 2/015; B60K 2001/0438

(57) ABSTRACT

A seat rail mounting structure includes a floor panel, a battery installed in a region under the floor panel, a seat rail positioned above the floor panel so as to extend along the vehicle longitudinal direction, and a floor R/F placed above the floor panel and including one or more floor members extending along a direction parallel to the seat rail, in which the floor R/F is welded to the floor panel, and the seat rail is mounted on the floor R/F.

### CROSS REFERENCE TO RELATED APPLICATION

This application claims priority to Japanese Patent Application No. 2025-071203 filed on Apr. 23, 2025, which is incorporated herein by reference in its entirety including the specification, claims, drawings, and abstract.

### TECHNICAL FIELD

This specification discloses a mounting structure for a seat rail which is placed above a floor panel.

### BACKGROUND

Seats slidable in a longitudinal direction are commonly installed in vehicles. The sliding movement of such seats is guided by seat rails. Conventionally, the seat rails have been fastened to a floor panel by bolts. With such configurations, the bolts penetrate and protrude through the bottom of the floor panel.

### CITATION LIST

### Patent Literature

Patent Document 1: JP 2017-193299 A

In recent years, it has become common to install a large battery in a vehicle under the floor panel. This creates a possibility that the battery may interfere with a bolt for fastening a seat rail. To avoid such interference, the installation position of the floor panel can be raised to separate the floor panel from the battery. However, raising the position of the floor panel can make it difficult for people to exit and enter the vehicle or require increasing the overall height of the vehicle.

In this connection, Patent Document 1 discloses a technique in which a cross member extending along the vehicle width direction is installed in a region on an upper side of the floor panel to screw fasten the seat rail to the cross member. When configured in this manner, bolts for fastening the seat rail do not protrude downwardly through the floor panel, and raising of the floor can be suppressed to a certain extent. However, the technique disclosed in Patent Document 1 is intended for use in a vehicle front seat and cannot be easily applied to seat rails for vehicle seats in the second or further following rows, located rearward of a seat cross member.

Under the circumstances, the present specification discloses a seat rail mounting structure which does not require raising the floor of a vehicle.

### SUMMARY

A seat rail mounting structure disclosed herein includes a floor panel, a battery installed in a region under the floor panel, a seat rail positioned above the floor panel and configured to extend along the vehicle longitudinal direction, a floor reinforcement positioned above the floor panel, the floor reinforcement including one or more floor members which extend along a direction parallel to the seat rail, in which the floor reinforcement is welded to the floor panel, and the seat rail is mounted on the floor reinforcement.

Here, the floor reinforcement may include two of the floor members located on opposite sides of the seat rail in the vehicle width direction and a coupling member configured to couple between the two of the floor members, and the seat rail may be mounted on the coupling member.

Further, bottom faces of the floor members may be welded to the floor panel, the coupling member may be suspended at a position above the floor panel, and the seat rail may be connected to the coupling member by staking in a state where a bottom face of the seat rail rests on the coupling member.

Still further, the floor reinforcement may be composed of one plate being folded, the floor member may be formed by folding a part of the plate into a rectangular shape, and a top face of the floor member may be located at a position higher than the bottom face of the seat rail and lower than a top face of the seat rail.

Moreover, the floor member may include an outer plate section upwardly extending from an end, in the vehicle width direction, of the coupling member.

According to the technique disclosed herein, because bolts downwardly protruding from the floor panel are eliminated, the floor panel can be brought close to the battery to thereby lower the floor surface.

### BRIEF DESCRIPTION OF DRAWINGS

Embodiments of the present disclosure will be described based on the following figures, wherein:

FIG. 1 is an exploded perspective view schematically showing a lower portion of a vehicle;

FIG. 2 is a cross-sectional view of a region around a seat rail;

FIG. 3 is a cross-sectional view showing a seat rail mounting structure according to a comparative example;

FIG. 4A is a drawing for explaining a difference between folding directions of a floor R/F; and

FIG. 4B is a drawing for explaining the difference between folding directions of a floor R/F.

### DESCRIPTION OF EMBODIMENTS

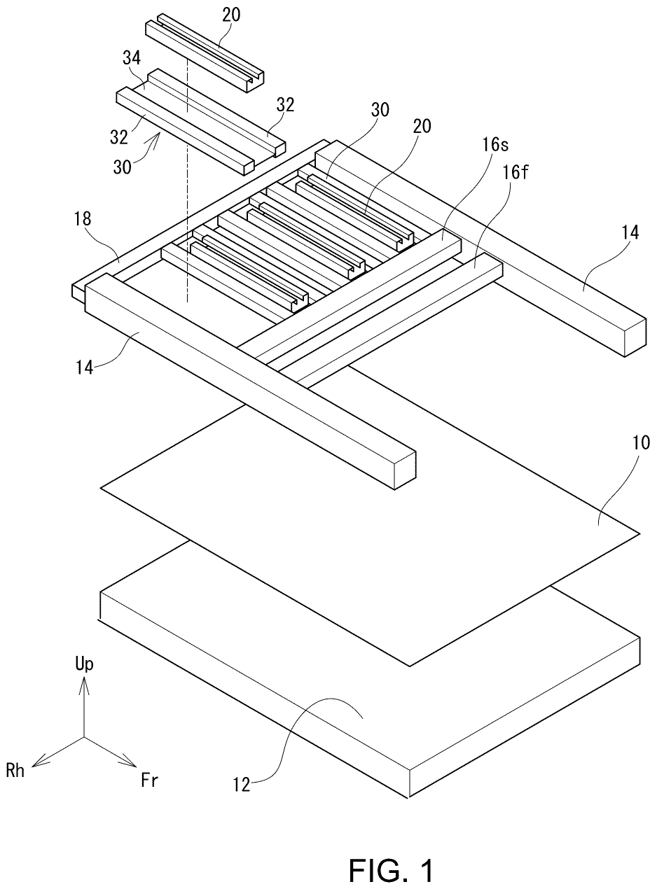

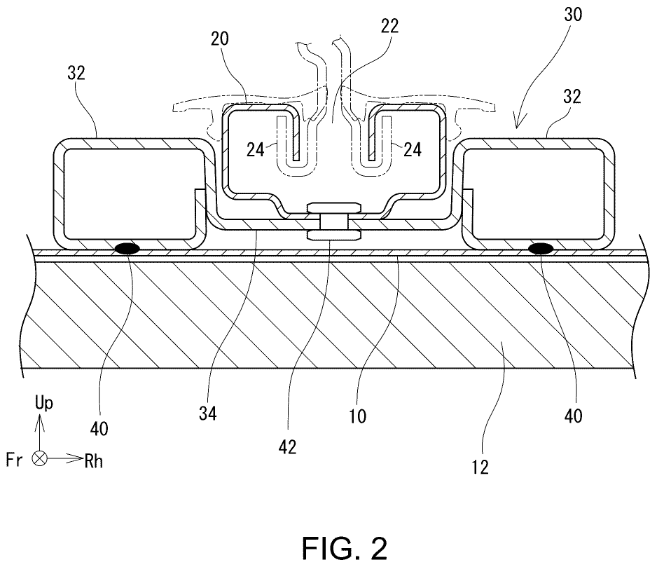

Hereinafter, a mounting structure for mounting a seat rail 20 will be explained with reference to the drawings. FIG. 1 is an exploded perspective view schematically showing a lower portion of a vehicle. FIG. 2 is a cross-sectional view showing a region around the seat rail 20. In the drawings, reference labels Up, Fr, Rh respectively indicate an upper side, a front side, and a right-hand side of the vehicle.

The mounting structure is applied to a vehicle, such as, for example, a battery electric vehicle, in which a large battery 12 is installed in a region under a floor panel 10. Further, the vehicle is a passenger vehicle including a slidable rear seat placed rearward of front seats (i.e., a driver seat and a front passenger seat).

A pair of side members 14 are arranged in the lower portion of the vehicle. The side members 14 are skeleton members extending along the vehicle longitudinal direction. Middle sections of the side members 14 are connected to each other by two seat cross members consisting of a first seat cross member 16f and a second seat cross member 16s. Further, rear ends of the side members 14 are also connected to each other by a rear cross member 18. The cross members 16f, 16s, and 18 are all skeleton members extending along the vehicle width direction. A seat rail of the front seat (not illustrated) is mounted on the first seat cross member 16f and the second seat cross member 16s.

The side members 14 are mounted on the floor panel 10. The floor panel 10 is a panel member constituting a floor of a vehicle compartment. The floor panel 10 is located below the above-described cross members 16f, 16s, and 18.

In addition, the battery 12 is installed in a region under the floor panel 10. The battery 12 is formed in a thin flat shape having a thickness significantly smaller than its dimensions in the plane of its flat shape, and a large size occupying an important area under the floor of the vehicle compartment. The placement height of the battery 12 is determined in consideration of avoiding interference of bumps or dips on the road as the vehicle travels.

Seat rails 20 and floor reinforcements 30 (hereinafter referred to as floor R/Fs 30) are placed between the second seat cross member 16s and the rear cross member 18. The seat rails 20 are configured to guide sliding movement of the rear seat (not illustrated). The seat rails 20 are located above the floor panel 10. The seat rails 20 are composed of a metal, such as, for example, steel, and manufactured by extrusion molding, for example. As shown in FIG. 2, the seat rail 20 has a substantially rectangular shape in cross section, and has a rail opening 22 extending along a longitudinal direction of the seat rail 20 on the top face thereof. A worker can access an inner region of the seat rail 20, particularly a bottom face of the seat rail 20, through the rail opening 22.

The seat rail 20 receives sliders 24 capable of sliding along the seat rail 20. Because the sliders 24 are connected to the rear seat, the rear seat is able to slide along the seat rail 20 together with the sliders 24. In this example, the seat rails 20 include four seat rails 20 which are arranged at an interval in the vehicle width direction.

The floor R/Fs 30 are reinforcing members disposed on the top face of the floor panel 10. Each of the floor R/Fs 30 includes, as shown in FIG. 2, a pair of floor members 32 and a coupling member 34 configured to couple between the floor members 32. Each of the seat rails 20 is positioned on the coupling member 34. Therefore, the number of floor R/Fs 30 is equal to the number of seat rails 20. In the example illustrated in FIG. 1, four floor R/Fs 30 are arranged.

Each of the floor members 32 is a skeleton member that has, as shown in FIG. 2, a substantially rectangular shape in cross section and extends in a direction parallel to the seat rail 20. The top face of the floor member 32 is located at a position higher than the bottom face of the seat rail 20 and lower than the top face of the seat rail 20. The floor members 32 are placed on opposite sides of the seat rail 20 in the vehicle width direction. A separation distance between the floor members 32 constituting a pair is substantially equal to or slightly greater than the dimension, in the vehicle width direction, of the seat rail 20. As such, even when the seat rail 20 is urged to incline with respect to its longitudinal axis in response to a load exerted on the seat rail 20, incline of the seat rail 20 is impeded by the floor members 32. As a result, the position and orientation of the seat rail 20 can be maintained appropriately. Here, the top face of the seat rail 20 protrudes upwardly from the top faces of the floor members 32. The floor members 32 are welded at their bottom faces to the floor panel 10. Black ellipses shown in FIG. 2 represent welding points 40. Each of the welding points 40 includes a plurality of welding points 40 spaced from each other in the longitudinal direction. Further, both longitudinal ends of each of the floor members 32 are respectively welded directly or indirectly via brackets or the like to other members, such as, for example, the second seat cross member 16s and the rear cross member 18.

The coupling member 34 couples the left and right floor members 32 constituting a pair. The coupling member 34 is a flat plate portion. As shown in FIG. 2, a slight gap is formed between the coupling member 34 and the floor panel 10, and the coupling member 34 is suspended above the floor panel 10. The seat rail 20 is arranged to rest on the coupling member 34 and fastened to the coupling member 34. In this example, the seat rail 20 and the coupling member 34 are fastened to each other by staking. Staking is a technique of fastening two components to each other through partial deformation of the components to be fastened (the coupling member 34 or the seat rail 20 in this example) or a fastening member.

In the example illustrated in FIG. 2, the seat rail 20 is fastened to the coupling member 34 by means of rivets 42. Specifically, the seat rail 20 and the coupling member 34 are perforated with a plurality of fastening holes defined at an interval along the longitudinal direction. The rivets 42 respectively inserted through the fastening holes are partially deformed, to thereby fasten the seat rail 20 to the coupling member 34. Here, the rivets 42 may be blind rivets with which fastening work can be finished by an operation performed only on one side. The use of blind rivets can ease a task of mounting the seat rail 20. Specific staking is not limited to use of the rivets 42, and staking may be implemented in other ways. For example, the seat rail 20 and the coupling member 34 may be stake-fastened to each other by deforming one or both of the seat rail 20 and the coupling member 34. In another example, spot staking may be performed in such a manner that the seat rail 20 is stacked on the coupling member 34 and punch-pressed along with the coupling member 34 for connection. In any case, a certain size of space is secured between the coupling member 34 and the floor panel 10, the size being large enough to enable connection by staking. For example, in a case of rivet fastening, a space which is slightly larger than the head of the rivet 42 is secured between the coupling member 34 and the floor panel 10.

Here, as can been seen from FIG. 2, the floor R/F 30 is composed of one folded plate. In other words, the coupling member 34 and the pair of floor members 32 constitute one seamless component. More specifically, the floor members 32 are formed by folding each of the ends, in the vehicle width direction, of the one plate multiple times at a substantially right angle so as to form an approximately rectangular shape. Here, folding enables formation of a region where two sections of the plate overlap each other. The overlapped sections are welded together. By forming the coupling member 34 and the floor members 32 from one plate in this manner, the number of components can be reduced, which can, in turn, reduce both the total labor and monetary costs of manufacturing the vehicle.

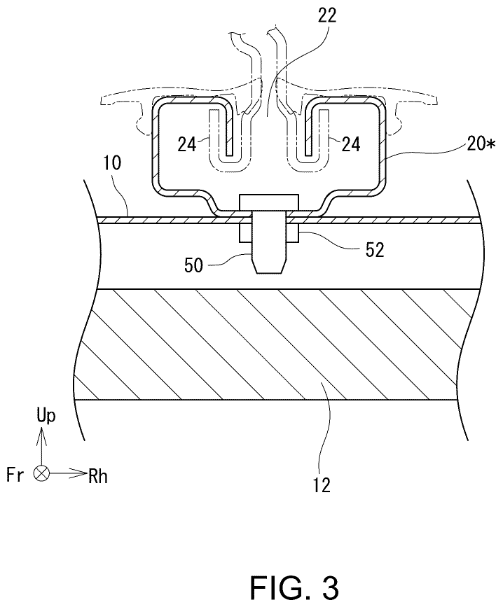

In this example, as is evident from the above description, the floor R/F 30 is placed at the position close to the seat rail 20, and the seat rail 20 is fastened, not to the floor panel 10, but to the floor R/F 30. The reason for employing this configuration will be explained through comparison with a comparative example. FIG. 3 is a cross-sectional view showing a mounting structure for a seat rail 20 * according to the comparative example. In the comparative example shown in FIG. 3, the seat rail 20 * is arranged to rest on the floor panel 10, and is directly bolt-fastened to the floor panel 10. That is, a fastening bolt 50 is inserted through the seat rail 20 * from above and is tightened by a nut 52 placed under the floor panel 10.

With this configuration, the shank of the fastening bolt 50 downwardly protrudes from the floor panel 10 as shown in FIG. 3. For this reason, it is in this comparative example necessary that the placement position of the floor panel 10 be raised to prevent physical contact between the fastening bolt 50 and the battery 12. However, as elevation of the placement position of the floor panel 10 increases, it becomes more difficult for a person to enter or exit the vehicle. Alternatively, when it is attempted to secure a broader space for the vehicle compartment while raising the placement position of the floor panel 10, the overall height of the vehicle must be increased problematically.

On the other hand, in the example, the seat rail 20 is staked to the coupling member 34 of the floor R/F 30. With staking, the downward protrusion is significantly smaller than when bolts are used for fastening. The floor R/F 30 itself is welded to the floor panel 10. For this reason, no fastening component protrudes downwardly from the floor panel 10, and as a result, the floor panel 10 can be brought close to the battery 12. In turn, the floor need not be raised as high, the vehicle is easier to enter or exit, and the overall height of the vehicle need not be increased.

If only considering prevention of such downward protrusion of the fastening member from the floor panel 10, welding of the seat rail 20 to the floor panel 10 may be considered over using the floor R/F 30. However, by not welding the seat rail 20 to the floor panel 10, the quality of the seat rail 20 can be maintained while also simplifying the component assembly process. Here, it is desirable that the seat rail 20 has a high degree of straightness to allow the slider 24 to slide smoothly on the seat rail 20. If the seat rail 20 is welded, it may be deformed due to welding heat, and any such deformation may hamper smooth sliding of the slider 24. Further, welding is often prohibited during the vehicle assembly process, which is when the seat rail 20 is mounted on the floor panel 10. For these reasons, it is desirable that the seat rail 20 be installed without the use of welding.

In a component manufacturing process of this example, the floor R/F 30 is welded to the floor panel 10 and manufactured as an integral component with the floor panel 10. Then, in the vehicle assembling process, the seat rail 20 is staked to the floor R/F 30. When configured in this manner, the geometry of the seat rail 20 can be accurately maintained while avoiding use of any components protruding downwardly from the floor panel 10.

Further, the floor members 32 placed on both sides of the seat rail 20 in the vehicle width direction can effectively prevent leaning of the seat rail 20. Still further, when the floor R/F 30 is provided, the overall stiffness of the vehicle is improved. Meanwhile, in the vehicle assembling process, both longitudinal ends of the floor members 32 may be respectively joined to the second seat cross member 16s and the rear cross member 18. In this way, the cross members 16s, 18 and the floor member 32 reinforce each other, which can still further enhance the stiffness of the vehicle.

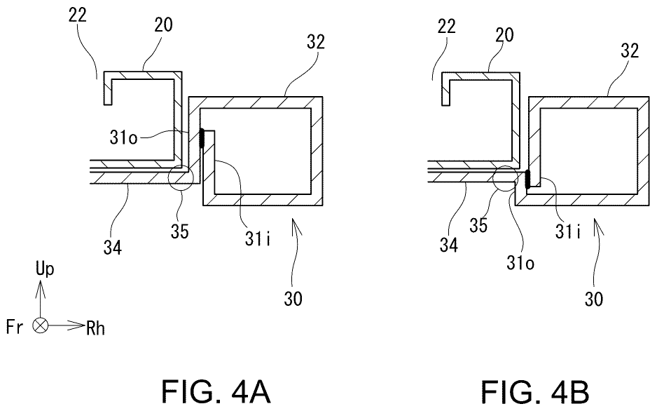

As has been explained above, in this example, the floor R/F 30 is composed of one plate. Such a configuration eliminates a seam between the floor member 32 and the coupling members 32, and accordingly increases the strength of the floor R/F 30. Further, in this example, as shown in FIG. 4A, a portion of the plate that extends from an end, in the vehicle width direction, of the coupling member 34 is folded upwardly at the end of the coupling member 34 (hereinafter, the end is referred to as a “terminal end 35”). As a result, the yield strength of the floor member 32 is further enhanced.

Here, the floor member 32 has a substantially rectangular shape in cross section. Among the four sides of such a rectangle, the side adjacent to the seat rail 20 is composed of an inner plate section 31i and an outer plate section 31o which externally covers a part of the inner plate section 31i. A configuration as shown in FIG. 4B is considered in which the outer plate section 31o extends downwardly from the terminal end 35 of the coupling member 34. In this configuration, the seat rail 20 abuts only the inner plate section 31i. As a result, when the seat rail 20 is urged to lean on the floor member 32, the load of the leaning seat rail 20 is received only by the inner plate section 31i, which may make a weld (indicated by a thick line in the drawing) between the inner plate section 31i and the outer plate section 31o to be vulnerable to exfoliation.

On the other hand, another instance according to this example shown in FIG. 4A is considered, in which the outer plate section 31o extends upwardly from the terminal end 35 of the coupling member 34. In this configuration, the seat rail 20 abuts the outer plate section 31o which in turn abuts the inner plate section 31i. Therefore, when the seat rail 20 is urged to lean on the floor member 32, the load of the leaning seat rail 20 is received by both the outer plate section 31o and the inner plate section 31i. As a result, the weld (indicated by a thick line in the drawing) between the inner plate section 31i and the outer plate section 31o is maintained without being exfoliated, and deformation and damage of the floor member 32 can in turn be effectively prevented with the example shown in FIG. 4A.

It is to be understood that the configurations and components explained above are presented merely by way of illustration and may be modified to the extent defined in Claim 1. In the above explanation, for example, the floor R/F 30 includes the pair of left and right floor members 32. However, the floor R/F 30 may include only one floor member 32. Further, the floor R/F 30 is formed of the one folded plate in the above explanation, but the floor R/F 30 may be formed by joining a plurality of metal sheets. Still further, a method for mounting the seat rail 20 on the floor R/F 30 is not limited to the connection by staking, and may include any connection method as long as the seat rail 20 can be mounted on the floor R/F 30.

### REFERENCE SIGNS LIST

10 floor panel, 12 battery, 14 side member, 16f first seat cross member, 16s second seat cross member, 18 rear cross member, 20 seat rail, 22 rail opening, 24 slider, 30 floor R/F, 31i inner plate section, 31o outer plate section, 32 floor member, 34 coupling member, 40 welding point, 42 rivet, 50 fastening bolt, 52 nut.

1. A seat rail mounting structure, comprising:
a floor panel;
a battery installed in a region under the floor panel;
a seat rail positioned above the floor panel and configured to extend along the vehicle longitudinal direction; and
a floor reinforcement positioned above the floor panel, the floor reinforcement comprising one or more floor members extending along a direction parallel to the seat rail, wherein
the floor reinforcement is welded to the floor panel; and
the seat rail is mounted on the floor reinforcement.

2. The seat rail mounting structure according to claim 1, wherein
the floor reinforcement comprises
two of the floor members disposed on opposite sides of the seat rail in the vehicle width direction, and
a coupling member configured to couple between the two of the floor members, and
the seat rail is mounted on the coupling member.

3. The seat rail mounting structure according to claim 2, wherein
a bottom face of the floor member is welded to the floor panel;
the coupling member is suspended above the floor panel; and
the seat rail is connected to the coupling member by staking, in a state where a bottom face of the seat rail rests on the coupling member.

4. The seat rail mounting structure according to claim 3, wherein
the floor reinforcement is composed of one folded plate;
the floor member is formed by folding a part of the plate into a rectangular shape; and
a top face of the floor member is located at a position higher than the bottom face of the seat rail and lower than a top face of the seat rail.

5. The seat rail mounting structure according to claim 4, wherein
the floor member comprises an outer plate section extending upwardly from an end, in the vehicle width direction, of the coupling member.
